(19) United States
(12) Patent Application Publication
(10) Pub. No.: US 2012/0113386 A1
(43) Pub. Date: May 10, 2012

(54) Small Optic Zone Contact Lenses And Methods

(75) Inventor: Arthur Back, Danville, CA (US)

(73) Assignee: COOPERVISION INTERNATIONAL HOLDING COMPANY, LP, St. Michael (BB)

(21) Appl. No.: 13/318,625

(22) PCT Filed: May 3, 2010
(86) PCT No.: PCT/US2010/033384

§ 371 Date: Jan. 13, 2012

Related U.S. Application Data
(60) Provisional application No. 61/175,211, filed on May 4, 2009.

(51) Int. Cl. G02C 7/06

(52) U.S. Cl. 351/159.13; 351/159.12; 351/159.79

(57) ABSTRACT

Contact lenses provide clear visual acuity and simultaneously present a myopic defocused image to the lens wearer at both near viewing distances and distant viewing distances. The present contact lenses have an optic zone that has a radius of less than or equal to 2.5 mm. Stated differently, the diameter of the optic zone of the present contact lenses is 5.0 mm or less. The present lenses are used in methods to reduce progression of myopia in a person capable of ocular accommodation. Methods of manufacturing the present lenses are described.

This application claims the benefit under 35 U.S.C. §119(e) of prior U.S. Provisional Patent Application No. 61/175,211, filed May 4, 2009, which is incorporated in its entirety by reference herein.

### FIELD

The present invention relates to contact lenses and methods, such as methods of making and methods of using the contact lenses. More specifically, the invention relates to new contact lenses and methods for reducing or preventing progression of myopia.

### BACKGROUND

Myopia, or near-sightedness, affects a substantial proportion of the world's population, especially in some Asian countries. Myopia is typically associated with an abnormal elongation of a person's eyeball. The elongated eyeball results in the retina being located out of the “normal” focal plane such that distant objects are focused in front of the retina rather than on the plane of the retina. The elongated eyeball associated with more severe myopia can also be associated with retinal detachment, glaucomatous damage and degenerative myopic retinopathy.

Efforts for reducing the progression of myopia have been attempted and include using multifocal spectacle or contact lenses, using lenses which affect optical aberrations, reshaping the cornea, and using pharmacological agents. Some ophthalmic lenses have been described for reducing progression of myopia that include a vision correction area that provides clear vision at near and distant viewing distances and a myopic defocus area that provides a defocused image at near and distant viewing distances. Difficulties associated with some of the proposed attempts at reducing myopia progression include pharmaceutical side effects, discomfort, compromised vision, or combinations thereof. Additional difficulties relate to the manufacture of such ophthalmic lenses since the special lens designs are required to provide the attempted reduction in myopia progression.

### SUMMARY

New contact lenses, and methods of using and methods of making the contact lenses have been invented. With the present contact lenses, a reduction or reductions in myopia progression, accommodative error, or both can be achieved. In other words, by providing the present contact lenses, it is possible for lens wearers to experience a reduction or elimination in progression of myopia, and exhibit reduced accommodative error in an eye or eyes compared to the eye or eyes without the lenses.

In one aspect, a contact lens is provided. For example, a hydrogel contact lens for reducing progression of myopia of an eye of a person capable of ocular accommodation, comprises a hydrogel lens body. The lens body comprises a substantially circular optic zone that includes the optic axis of the lens and is defined by an outermost optic zone perimeter. The lens body also comprises a peripheral zone substantially adjacent to and circumscribing the optic zone perimeter, and a peripheral edge zone circumscribing the peripheral zone. The optic zone has a radius from the center of the optic zone to the outermost optic zone perimeter of less than or equal to 2.5 mm. Thus, the optic zone diameter is 5.0 mm or less. The optic zone is the only region of the lens body that provides clear visual acuity to an eye of a person on which the contact lens is placed. As used herein, clear visual acuity is typically determined by an optician providing a visual acuity test, such as by using a standard letter chart. For the purposes of this disclosure, clear visual acuity can mean that a lens wearer has a vision score from about 20/40 to about 20/10 when wearing the present contact lenses and when viewing far target distances, such as a target distance of 600 cm. The present contact lens is effective in controlling progression of myopia, or reducing the rate of progression of myopia, or combinations thereof, in the eye of the person.

At least one example of the present contact lenses is a contact lens comprising a hydrogel lens body comprising a centrally located substantially circular optic zone that includes the optic axis of the lens and is defined by an outermost optic zone perimeter. A peripheral zone is substantially adjacent to and circumscribes the optic zone perimeter. The peripheral zone can be understood to be a non-optical peripheral zone since it is located radially outwardly of the optic zone perimeter. The non-optical peripheral zone provides a lower visual acuity compared to the central circular optic zone, such that the visual accuity provided by the central optical zone is defined as A, and the visual acuity provided by the non-optical peripheral zone is defined as B, and the relationship of B to A is defined by the following equation: B<(A+0.05).

In another aspect, a method for reducing myopia progression in a patient capable of ocular accommodation is described. The method comprises providing one or more contact lenses as described herein. Thus, in some aspects, the invention relates to the use of the present contact lenses for reducing myopia progression in a patient capable of ocular accommodation.

In a further aspect, a method of manufacturing contact lenses is described. In one example, the method comprises forming a lens forming material in the present contact lenses as described herein. In another example, the method comprises using a lens design as described herein.

In a further aspect, a method for reducing accommodative error of a patient capable of ocular accommodation is described. The method comprises providing one or more contact lenses as described herein. In such methods, a reduced accommodative error is observed.

Aspects of the present invention are also described by the appended claims.

Various embodiments of the present invention are described in detail in the detailed description below. Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention. Additional advantages and aspects of the present invention are apparent in the following detailed description, drawings, and claims.

### BRIEF DESCRIPTION OF THE DRAWINGS

FIG. 1 is a front plan view of a contact lens in accordance with the present disclosure.

FIG. 2 is a sectional view illustrating a peripheral edge zone of the present contact lenses.

### DETAILED DESCRIPTION

The present contact lenses have optical designs that are easier to manufacture than contact lenses having more complex optical designs, yet the present contact lenses are useful in reducing the progression of myopia in a person or people who are capable of ocular accommodation. A contact lens of the present invention can be placed on an eye of a myopic person or a person predisposed to becoming myopic and is effective in reducing further progression of myopia in a myopic person or reducing progression of myopia in a person predisposed to becoming myopic. As used herein, the words “a” or “an” mean one or more and are used interchangeably with the phrase “at least one”. In addition, with the present lenses, accommodative error in such persons can be reduced and the accuracy of accommodation can be improved, such as by reducing accommodative error, including accommodative lead or accommodative lag. Furthermore, long-term reading improvement may be achieved with the present contact lens. The change effects provided by the present contact lenses may be observed by an optician, such as an optometrist or an ophthalmologist, or may be observed by a machine configured to measure ocular parameters, such as axial length of the eyeball, accommodative error, visual acuity, or combinations thereof. In addition, the effects may be observed by the patient or lens wearer by improved vision performance, improved visual acuity, or other quantifiable measure of vision improvement.

Myopia progression refers to the increase or development of myopia over time. In children who are myopic or who are predisposed to becoming myopic, they generally experience an increase in myopia as the child ages. As stated herein, the increase in myopia is associated with an elongation of the eyeball, which can further lead to other severe ocular conditions, such as retinal detachment, among other things. Thus, the present lenses are effective in slowing the rate of myopia progression in a child such that as the child ages, the myopia remains substantially stabilized and does not progress to a degree that would be considered to a severe ocular condition by a clinician.

Ocular accommodation refers to an optical change in the power of the eye. Typically, ocular accommodation refers to the ability of the eye to change the refractive power of the eye's lens by changing the shape of the ocular lens. When a patient has no accommodative error, the patient does not have an accommodative lag or an accommodative lead. Accommodative lag is the amount by which the accommodative response of the eye is less than the dioptric stimulus to accommodation. Accommodative lead is the amount by which the accommodative response of the eye is greater than the dioptric stimulus to accommodation. Prior to becoming presbyopic, a person is able to sufficiently accommodate; however, a person's ability to accommodate deteriorates over time.

Myopic patients (myopes) have been described as having larger lag of ocular accommodation compared to emmetropic patients (emmetropes). The larger lag of accommodation is illustrated as a larger accommodative error compared to the accommodative error of emmetropes. A patient with no accommodative lag or no accommodative lead has an accommodative error of zero. Similarly, a patient with an accommodative lag has a negative accommodative error, and a patient with an accommodative lead has a positive accommodative error. The extent of the accommodative error is commonly measured in diopters.

The present contact lenses described herein are effective in reducing progression of myopia, or reducing accommodative error, or both in a human patient that is capable of ocular accommodation. Thus, the present lenses, methods, and uses are particularly beneficial for non-presbyopic patients since presbyopic patients or presbyopes have diminished or no ability to accommodate. Presbyopia is most frequently diagnosed in people who are about forty years old or older. Thus, the present methods and uses are beneficial for patients less than forty years old. The methods and uses can be useful in young adults, or children, or both. For example, the present methods and uses are effective in reducing accommodative error or improving accommodative accuracy in patients less than twenty-five years old.

To measure myopia, accommodative error, and reading performance, conventional equipment and methods can be used as understood by persons of ordinary skill in the art. For example, a retinoscope or a refractometer can be used to measure accommodative responses at different distances, such as at near, intermediate, or far target distances. An example of a retinoscope that can be used is the ELITE retinoscope available from WelchAllyn (Skaneateles Falls, N.Y., USA) and an example of a refractometer that can be used is the WR-5100K available from Grand Seiko (Fukuyama, Japan). Additional retinoscopes that can be used are available from companies such as Keeler (Windsor, UK) and Heine (Herrsching, Germany). In a clinical setting, at least one accommodative error measurement is made at a near distance, such as 40 cm, and at least one accommodative error measurement is made at a far distance, such as 6 m (600 cm) or virtual infinity. Examples of targets that can be used to measure accommodative error include conventional eye charts, such as a Snellen eye chart, or a logMAR visual accuity chart, or a Maltese cross. Single accommodative error measurements can be made or multiple accommodative error measurements can be made and averaged to provide an indication of the accommodative error for the patient's eye. Accommodation responses can be recorded for both eyes or for one eye, as desired. As is understood, since some aspects of ocular function are controlled by yoked muscles, frequently, accommodation is only measured in one eye. The accommodative error of the eye can be observed by measuring the accommodative error in the eye without the contact lens, but while the patient is viewing the target with the ophthalmic lens.

Near distances are typically considered to be less than 60 cm, and tests are routinely done at a 40 cm viewing distance. Far distances are typically considered to be at least 400 cm, and tests are routinely done at a 600 cm viewing distance. Intermediate distances are typically between about 60 cm and about 400 cm.

Thus, an aspect of the present invention relates to a new contact lens. The contact lens is a soft contact lens in that it can conform to the shape of the cornea when placed on a person's eye. A soft contact lens can also be understood to be a lens that is foldable upon itself without breaking. The contact lens can be a hydrogel contact lens. As used herein, a hydrogel contact lens refers to a polymeric lens that has the ability to absorb and retain water in an equilibrium state. In the context of the present description, a hydrogel lens can be a polymeric material that is free of a silicone-containing component, or a hydrogel lens can be a polymeric material that includes a silicone-containing component. Many silicone-free hydrogel contact lenses are based on polymerizable lens formulations that include hydroxyethyl methacrylate (HEMA) monomers. Some examples of hydrogel contact lens materials include materials having the following US Adopted Names (USANs): etafilcon A, nelfilcon A, ocufilcon A, ocufilcon B, ocufilcon C, ocufilcon D, and omafilcon A. In addition, the present contact lenses may be hydrogel contact lenses that are based on lens formulations that contain glyceryl methacrylate (GMA) alone or in combination with HEMA. Silicone-containing hydrogel contact lenses are frequently referred to as silicone hydrogel contact lenses. Many silicone hydrogel contact lenses are based on polymerizable lens formulations that include siloxane monomers, oligomers, or macromers. Some examples of silicone hydrogel contact lens materials include materials having the following USANs: acquafilcon A or aquafilcon A, balafilcon A, comfilcon A, enfilcon A, galyfilcon A, lenefilcon A, lotrafilcon A, lotrafilcon B, and senofilcon A.

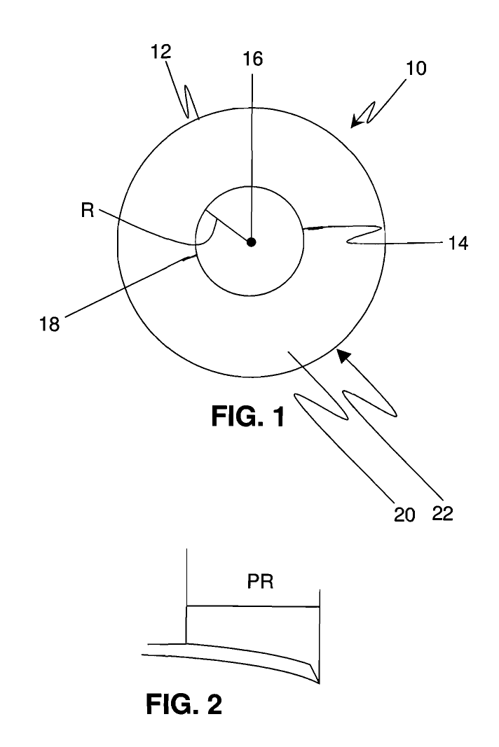

As shown in FIG. 1, the hydrogel contact lens 10 comprises a hydrogel lens body 12. The lens body 12 comprises a substantially circular optic zone 14. The optic zone 14 is located in a central region of the lens body 12. The optic zone includes the optic axis 16 of the lens body 12. The optic zone 14 is defined by an outermost optic zone perimeter 18. A peripheral zone 20 is provided substantially adjacent to the optic zone perimeter 18 and circumscribes the optic zone perimeter 18. The lens body 12 also includes a peripheral edge zone 22 that circumscribes the peripheral zone. Unlike existing contact lenses, the optic zone 14 is defined by a radius R to the outermost optic zone perimeter that is less than or equal to 2.5 mm when the contact lens is in a hydrated state (e.g., when the hydrogel contact lens has an equilibrium water content of between 10% and 90%). In other words, the radius extending from the center of the optic zone to the outermost optic zone perimeter is less than or equal to 2.5 mm. The radius is determined by measuring a straight line distance on a plan view of the contact lens, as shown in FIG. 1. Thus, the diameter of the optic zone 14 of the hydrated contact lens is 5.0 mm or less. As used herein, the optic zone 14 is the only region of the lens body 12 that provides clear visual acuity to the person in an eye on which the contact lens is placed. It will be understood that in order to provide clear visual acuity, the diameter of the optic zone has a minimum value. In the present lenses, the diameter of the optic zone of a hydrated contact lens is at least 3.0 mm. Thus, the diameter of the optic zone of the present hydrated contact lenses is between 3.0 mm and 5.0 mm. The radius of the optic zone of the present hydrated contact lenses is between 1.5 mm and 2.5 mm. A contact lens with such an optic zone is effective in reducing progression of myopia in the eye of the person. The overall straight line diameter of the present contact lenses is between 11.0 mm and 15.0 mm, and frequently, is between 13.0. and 15.0 mm. Thus, the radial width of the peripheral zone 20 is between 3.0 mm and 5.0 mm.

In one example of the present contact lenses, a contact lens comprises a lens body having a single optic zone having an optic zone diameter between 3.3 mm and 5.0 mm, as described herein.

The optic zones of the present contact lenses provide a visual acuity A, the peripheral zones provide a visual acuity B, such that the relationship of B to A is defined by the following equation: B<(A+0.05).

The visual acuity of the non-optical peripheral zone can be measured in contact lenses in which the central optic zone is masked by an opaque disc shaped aperture placed in a standard trial frame about the same size as the central optic zone and aligned over the central optic zone. Alternatively, an opaque tinted mask can be applied onto the front surface of the contact lens over the central optic zone leaving the peripheral non-optic zone unmasked. These opaque masks or tints are applied to the contact lenses using conventional methods and equipment.

As can be appreciated from the lens illustrated in FIG. 1, the present contact lenses can be understood to have only two visually identifiable borders or perimeters providing a visual indication of the different zones of the lenses. For example, when viewed under a lens inspection device, the present lenses can be seen to comprise zone borders or zone perimeters that consist of a first perimeter located relatively closer to the geometric center of the contact lens and defining the perimeter of the optic zone, and a second perimeter spaced radially outward from the first perimeter and defining the border between the outer portion of the peripheral zone and the inner portion of the peripheral edge zone. This is unlike contact lenses which have a central optic zone circumscribed by a peripheral optic zone and that is circumscribed by a peripheral zone or carrier zone.

The present contact lenses are hydrogel contact lenses. The hydrogel contact lens can be a silicone-free hydrogel contact lens, orthe contact lens or the lens body can be a silicone hydrogel.

In comparison to existing concentric ring contact lenses, such as bifocal and multifocal contact lenses, the present contact lenses can comprise an optic zone that comprises only one effective refractive power. Stated differently, the optic zone comprises a single effective refractive power. That is, the optic zone of the contact lens when measured by a vertometer or focimeter, as used in contact lens manufacturing environments, may appear to have a single refractive power. Thus, the optic zone may have one or more aspheric surfaces that provide more than one refractive power to the vision correction region, but where the lens still has an effective single refractive power, as measured by a vertometer or focimeter. Thus, the present contact lenses can have an optic zone that has only one effective refractive power, and the refractive power is defined by a surface of the lens body having a spherical curvature, an aspherical curvature, or both. The amount of spherical or aspherical curvature, or both, indicates how much refractive power the optic zone provides to the contact lens wearer. This is unlike contact lenses which have a central optic zone circumscribed by a peripheral optic zone, with or without a transition zone provided between the central optic zone and the peripheral optic zone, where such contact lenses with dual optic zones have more than one effective refractive power.

The present contact lenses can comprise a lens body that further comprises a toric optic zone providing cylindrical power or cylinder power. Thus, the present contact lenses may be considered to be toric contact lenses and are useful in correcting astigmatic vision. Where the present contact lenses include a central circular optic zone as described herein, and a toric optic zone, the central circular zone can be understood to be a first optic zone and the toric optic zone can be understood to be a second optic zone. The first optic zone can be provided on the front surface of the contact lens, and the second optic zone can be provided on the opposing back surface of the contact lens. This option can be understood to be a back surface toric contact lens. As an option, the first optic zone can be provided on the back surface of the contact lens, and the second optic zone can be provided on the front surface of the contact lens. This option can be understood to be a front surface toric contact lens. As understood by persons of ordinary skill in the art, a tonic optic zone has two diameters, a short diameter corresponding to the diameter along the short axis or minor axis of the toric optic zone, and a long diameter corresponding to the diameter along the long axis or major axis of the tonic optic zone. With the toric contact lenses, the short axis of the toric optic zone can have a diameter that is equal to the diameter of the first optic zone. For example, when the first optic zone has a diameter of 5.0 mm, the short axis of the tonic optic zone can have a diameter of 5.0 mm. As an option, the short axis of the toric optic zone can have a diameter that is less than the diameter of the first optic zone. Such an option may include a blending region where the cylinder power along the short axis is blended into the curvature of the peripheral zone. The major axis of the toric contact lenses may have a diameter greater than the diameter of the first optic zone.

In any of the present contact lenses, a portion of the peripheral zone is effective in providing myopic defocus to the lens wearer.

The optic zone of the present contact lens is structured to provide clear visual acuity at both near viewing distances and at far viewing distances. In comparison to existing concentric ring bifocal and multifocal contact lenses which have an optic zone diameter of about 8 mm and a plurality of alternating concentric rings circumscribing a small central zone, the present contact lenses provide a single vision correction region that provides both near and far visual acuity correction. For existing multifocal contact lenses, lens wearers rely on the distance vision zones to provide distance visual acuity and rely on the near vision zones to provide near visual acuity.

In the present invention, the myopic defocus provided by a portion of the peripheral zone is provided to the lens wearer at both near viewing distances and far viewing distances simultaneously when the lens wearer is provided with clear visual acuity. Thus, the myopic defocus is provided by a portion of the lens located outside of the optic zone, as described herein. The portion of the lens providing the myopic defocus can be considered to be a portion of the peripheral zone or carrier zone.

The optic zone is structured, such as sized and shaped, to provide clear distance visual acuity at far distances, and to provide clear near visual acuity at near distances. The optic power of the optic zone can be a value from about 0.0 diopters to about −10.0 diopters. Such optic powers provide effective distance visual acuity when the lens wearer is viewing far distances and there is effectively no accommodation. In addition, by providing an optic zone that has a diameter of 5.0 mm or less, it is possible to provide a vision correction region that provides near visual acuity at near viewing distances as the eye is accommodating. It is now realized that with such optic zone diameters and patients who can accommodate, providing an optic zone diameter of 5.0 mm or less can provide perceptably acceptable visual acuity without interfering with the patient's vision. For example, prior to the present invention, it was believed that optic zone diameters needed to exceed the size of the pupil to reduce the chance that light would pass through the lens outside the optic zone and provide a different refractive effect. Thus, existing contact lenses typically have an optic zone diameter of about 8.0 mm. The present invention is based on the effect that providing an optic zone diameter that is 5.0 mm or less provides clear visual acuity at far viewing distances and near viewing distances, but that the peripheral zone outside the optic zone perimeter provides myopic defocus to the patient at both far viewing distances and near viewing distances.

As used herein, clear visual acuity is typically determined by an optician providing a visual acuity test, such as by using a standard letter chart. For the purposes of this disclosure, clear visual acuity can mean that a lens wearer has a vision score from about 20/40 to about 20/10 when wearing the present contact lenses and when viewing far target distances, such as a target distance of 600 cm.

When viewing an illustration or image of the present contact lenses, as shown in FIG. 1, the lens body is seen to have a single junction, which occurs at the optic zone perimeter. The contact lens can comprise a transition surface (not shown) between the optic zone and the peripheral zone. The transition surface is effective in blending or smoothing the junction at the optic zone perimeter to make the lens more comfortable to the lens wearer compared to a lens with a distinct junction. The transition surface is provided by shaping the surface with a radius of curvature that is different than the surface curvature radius of the optic zone and the surface curvature radius of the peripheral zone. For example, the radius of curvature of the transition zone(s) differs by at least 0.05 mm from the immediately adjacent curvature(s) of the optic zone and peripheral zone. The transition surface of some of the present contact lenses will provide some myopic defocus to the lens wearer when the lens wearer is wearing the present lenses. It can be understood that the myopic defocus provided by the transition surface will typically be less than the maximum myopic defocus provided by more peripheral regions of the contact lens. The transition surface can provide a transition between providing the wearer with clear visual acuity adjacent the outermost optic zone perimeter and myopic defocus adjacent an innermost peripheral zone perimeter.

In addition, the peripheral zone of the present contact lenses can be defined by a surface that is free of a transition surface between the optic zone perimeter and the peripheral edge zone. Thus, a contact lens can comprise a lens body that has a single surface curvature in the optic zone and a single surface curvature in the peripheral zone. Some lenses may have a third surface curvature at the transition surface as described in the preceding paragraph. Additional surface curvatures can be provided in the peripheral edge zone. Thus, a contact lens can comprise a lens body having a surface, such as an anterior surface that consists essentially of no more than three different radii of curvature across the optic zone, the peripheral zone, and the optional transition zone.

The present contact lenses can comprise a lens body comprising an optic zone that has an effective single refractive power for correcting a person's distance visual acuity. The optic zone is sized, such as by having a diameter of about 5.0 mm or less, to provide clear visual acuity to the person at a target distance less than 60 cm, such as when the person is accommodating. The peripheral zone, or a portion thereof, provides myopic defocus at the same time the person sees a clear near image at the target distance. Thus, it can be understood that that the peripheral zone has a curvature effective to provide the peripheral zone with an optical power that is less negative than the single refractive power of the optic zone (e.g., the refractive power of the peripheral zone can be from +1.0 to +6.0 diopters relative to the single refractive power of the optic zone).

In view of the above, it can be understood that another aspect relates to methods for reducing progression of myopia of an eye of a person capable of ocular accommodation. In practising the present methods, a contact lens is provided. In other words, a method for reducing progression of myopia in a person capable of ocular accommodation comprises a step of providing at least one contact lens. The contact lens is to be placed on a patient's eye that is capable of ocular accommodation. The contact lens is any of the contact lenses described above. Broadly, the contact lens comprises a substantially circular optic zone that includes the optic axis of the lens and is defined by an outermost optic zone perimeter, a peripheral zone substantially adjacent to and circumscribing the optic zone perimeter, and a peripheral edge zone circumscribing the peripheral zone, wherein the optic zone has a radius from the center of the optic zone to the outermost optic zone perimeter of less than or equal to 2.5 mm, and wherein the optic zone is the only region of the contact lens that provides clear visual acuity to the person in an eye on which the contact lens is placed, and the contact lens is effective in reducing progression of myopia in the eye of the person. The peripheral edge zone can have a radial distance PR (as shown in FIG. 2) extending from the outermost point of the contact lens edge towards the optic center of the contact lens that is about 2 mm or less. The radial length of the peripheral edge zone can be about 1.5 mm, or about 1.0 mm, or about 0.5 mm. The peripheral edge zone radial distance can also be less than each of the preceding distances. The radial measurements can be determined by measuring the distance in a 2 dimensional representation of the contact lens. The representation can be a plan view of the lens or a sectional view through the optic center of the lens.

In the present methods, the providing may comprise providing the lens to a lens distributor, providing a lens to an optician, such as an optometrist or ophthalmologist, providing the lens to the patient, or combinations thereof. The present methods can be directed at a lens manufacturer providing contact lenses to lens distributors, such as lens retailers, who may then provide the lenses to opticians or patients. The present methods can be directed at a lens manufacturer or a lens distributor providing contact lenses to opticians. The methods can be directed at opticians providing the lenses to patients, and instructing the patients on how to wear the lenses.

In further methods, such as the methods described in preceding paragraphs, the providing step may consist essentially of providing the lens to a lens distributor, providing a lens to an optician, such as an optometrist or ophthalmologist, providing the lens to the patient, or combinations thereof. In still further methods, such as the methods in the preceding paragraph, the providing step may consist of providing the lens to a lens distributor, providing a lens to an optician, such as an optometrist or ophthalmologist, providing the lens to the patient, or combinations thereof

In any of the present methods, the providing step may comprise providing first and second lenses. The providing can comprise providing a first box of lenses, or providing a first box and a second box of lenses.

In some situations, an aspect of the present invention can be understood to be the use of a contact lens for reducing progression of myopia in a person capable of ocular accommodation. The contact lens can be any of the contact lenses described herein.

Another aspect of the invention relates to methods of manufacturing contact lenses,for example, a method of manufacturing a contact lens for reducing progression of myopia in a patient capable of ocular accommodation. The method comprises forming a lens forming material into a contact lens to be placed on a person's eye that is capable of ocular accommodation. The contact lens comprises a substantially circular optic zone that includes the optic axis of the lens and is defined by an outermost optic zone perimeter, a peripheral zone substantially adjacent to and circumscribing the optic zone perimeter, and a peripheral edge zone circumscribing the peripheral zone. The optic zone has a radius from the center of the optic zone to the outermost optic zone perimeter of less than or equal to 2.5 mm. In addition, the optic zone is the only region of the contact lens that provides clear visual acuity to an eye of a person on which the contact lens is placed. Any of the contact lenses described herein can be manufactured in the present method. The contact lens so manufactured is effective in reducing progression of myopia in the eye of the person.

The present contact lenses may be the polymerized reaction product of a polymerizable composition that comprises one or more hydrophilic monomers, one or more hydrophobic monomers, one or more silicone-containing monomers, oligomers, or macromers, one or more polymers, or combinations thereof In addition, the polymerizable compositions used to make the present lenses may include crosslinking agents, free radical initiators, tinting agents, UV absorbers, and the like. The present soft contact lenses may comprise, consist essentially of, or consist of, any of the foregoing contact lens materials identified by the USAN names above. The present lenses can be made from omafilcon A. The present lenses can be silicone hydrogel contact lenses that are made from comfilcon A or enfilcon A.

The present contact lenses can be molded contact lenses, such as spin-cast molded or cast molded contact lenses, or lathed contact lenses. It can be appreciated that these types of contact lenses can have different physical features resulting from their method of manufacture. A cast molded contact lens refers to a contact lens obtained from a contact lens mold assembly formed from two contact lens mold sections in contact with each other to form a contact lens shaped cavity. In addition, a portion of the present contact lenses can be polished or smoothed after forming the contact lens. For example, a contact lens that has been cast molded or lathed, or both, can be polished to reduce transition areas or improve edge shapes to provide greater comfort compared to unpolished lenses.

The present contact lenses can be daily wear lenses or extended wear lenses. As used herein, an extended wear contact lens refers to a contact lens that is approved for wearing on a continuous basis for more than 24 hours. Each contact lens of the lens pair can be a daily disposable contact lens (i.e., a contact lens that is worn on a person's eye only once and then discarded). In comparison, as understood by persons of ordinary skill in the art, a daily wear lens is a lens that is worn on a person's eye, and is then cleaned and is worn on the person's eye for at least one additional time. It can be appreciated that daily disposable contact lenses can be physically different, chemically different, or both compared to daily wear and extended wear contact lenses. For example, formulations used to make daily wear or extended wear contact lenses are different than formulations used to make daily disposable contact lenses due to the economic and commercial factors in making substantially larger volumes of daily disposable contact lenses.

The present contact lenses are placed on a patient's eye such that the posterior surface of the lens faces the corneal epithelium of the eye of the patient.

When the contact lenses are cast molded contact lenses, the forming step comprises cast molding a polymerizable composition into the shape of a contact lens, separating the cast molded contact lens from a contact lens mold member, contacting the separated cast molded contact lens with a liquid, inspecting the separated cast molded contact lens, packaging the separated cast molded contact lens in a contact lens package, and/or sterilizing the contact lens in the package, or any combinations thereof.

One method of forming a cast molded contact lens is as follows. First and second mold members are produced. The first and second mold members are structured to be coupled together to form a contact lens mold assembly. The first mold member is a front surface mold member, and it includes a concave lens forming surface which will form the front surface of the contact lens. The second mold member is a back surface mold member, and it includes a convex lens forming surface which will form the back surface of the contact lens. The first mold member is produced to include one or more surface curvatures on its concave surface. The surface curvatures are dimensioned to provide a vision correction region and a myopic defocus region as described herein. A polymerizable composition is produced and includes reactive ingredients, and optionally non-reactive ingredients, used in forming contact lenses. The ingredients can include one or more hydrophilic monomers, oligomers, macromers, or polymers; and/or one or more hydrophobic monomers, oligomers, macromers, or polymers; and/or one or more silicone-containing monomers, oligomers, macromers, or polymers; or any combinations thereof. The polymerizable composition is dispensed onto the concave surface of the first mold member. The second mold member is placed against the first mold member to form a contact lens mold assembly having a contact lens shaped cavity with the polymerizable composition located therein. The contact lens mold assembly is then exposed to heat or light to polymerize the polymerizable composition and form a polymerized contact lens product. The contact lens mold assembly is demolded by separating the first and second mold members. The polymerized contact lens product remains attached to the first or the second mold member, and is then delensed or separated from the mold member. The delensed contact lens is contacted with a liquid, which may be a washing liquid, or it may be a packaging liquid. In some methods, the washing liquid includes one or more agents to help extract unreacted or partially reacted ingredients from the delensed contact lens product. Methods can include one or more steps of inspecting the lens in a dry state, a wet state, or both. The inspection can include inspecting for defects or inspecting for quality control purposes. Once the lenses are placed in a packaging liquid, the packages can be sealed, and sterilized.

Although the disclosure herein refers to certain specific embodiments, it is to be understood that these embodiments are presented by way of example and not by way of limitation. The intent of the foregoing detailed description, although discussing exemplary embodiments, is to be construed to cover all modifications, alternatives, and equivalents of the embodiments as may fall within the spirit and scope of the invention as defined by the claims.

What is claimed is:

1. A hydrogel contact lens for reducing progression of myopia of an eye of a person capable of ocular accommodation, comprising:
a hydrogel lens body, the lens body comprising a substantially circular optic zone that includes the optic axis of the lens and is defined by an outermost optic zone perimeter, a peripheral zone substantially adjacent to and circumscribing the optic zone perimeter, and a peripheral edge zone circumscribing the peripheral zone,
wherein the optic zone has a radius from the center of the optic zone to the outermost optic zone perimeter less than or equal to 2.5 mm,
wherein the optic zone is the only region of the lens body that provides clear visual acuity to an eye of a person capable of ocular accommodation on which the contact lens is placed, and the contact lens is effective in reducing progression of myopia in the eye of the person, and
wherein the optic zone provides a visual acuity A, the peripheral zone provides a visual acuity B, such that the relationship of B to A is defined by the following equation: B<(A+0.05).

2. The contact lens of claim 1, wherein the lens body is a silicone hydrogel.

3. The contact lens of any preceding claim, wherein the optic zone comprises only one effective refractive power.

4. The contact lens of claim 3, wherein the refractive power is defined by a surface of the lens body having a spherical curvature, an aspherical curvature, or both.

5. The contact lens of any preceding claim, wherein the lens body further comprises a toric optic zone providing cylindrical power.

6. The contact lens of any preceding claim, wherein a portion of the peripheral zone circumscribing the optic zone is effective in providing myopic defocus to a lens wearer.

7. The contact lens of any preceding claim, wherein the optic zone is structured to provide clear visual acuity at both near viewing distances and far viewing distances.

8. The contact lens of any preceding claim, further comprising a transition surface between the optic zone and the peripheral zone.

9. The contact lens of any preceding claim, wherein the peripheral zone is defined by a surface that is free of a transition surface between the optic zone perimeter and the peripheral edge zone.

10. The contact lens of any preceding claim, wherein the optic zone has an effective single refractive power for correcting the person's distance visual acuity, the optic zone providing clear visual acuity to the person at a target distance less than 60 cm, and the peripheral zone provides myopic defocus at the same time the person sees a clear near image at the target distance.

11. A method for reducing progression of myopia of an eye of a person capable of ocular accommodation, comprising:
providing a hydrogel contact lens, the contact lens comprising a substantially circular optic zone that includes the optic axis of the lens and is defined by an outermost optic zone perimeter, a peripheral zone substantially adjacent to and circumscribing the optic zone perimeter, and a peripheral edge zone circumscribing the peripheral zone, wherein the optic zone has a radius from the center of the optic zone to the outermost optic zone perimeter of less than or equal to 2.5 mm, wherein the optic zone is the only region of the contact lens that provides clear visual acuity to the person in an eye on which the contact lens is placed, and the contact lens is effective in reducing progression of myopia in the eye of the person, and wherein the optic zone provides a visual acuity A, the peripheral zone provides a visual acuity B, such that the relationship of B to A is defined by the following equation: B<(A+0.05).

12. The method of claim 11, wherein the providing comprises providing the lens to a lens distributor, providing the lens to an optician, providing the lens to the patient, or combinations thereof.

13. The method of claim 11 or claim 12, wherein the providing comprises providing first and second lenses.

14. Use of a contact lens for reducing progression of myopia in a person capable of ocular accommodation, the contact lens comprising a substantially circular optic zone that includes the optic axis of the lens and is defined by an outermost optic zone perimeter, a peripheral zone substantially adjacent to and circumscribing the optic zone perimeter, and a peripheral edge zone circumscribing the peripheral zone, wherein the optic zone has a radius from the center of the optic zone to the outermost optic zone perimeter of less than or equal to 2.5 mm, wherein the optic zone is the only region of the contact lens that provides clear visual acuity to the person in an eye on which the contact lens is placed, and the contact lens is effective in reducing progression of myopia in the eye of the person, and wherein the optic zone provides a visual acuity A, the peripheral zone provides a visual acuity B, such that the relationship of B to A is defined by the following equation: B<(A+0.05).

15. A method of manufacturing a contact lens for reducing progression of myopia in a patient capable of ocular accommodation, comprising:
forming a lens forming material into a contact lens to be placed on a person's eye capable of ocular accommodation, the contact lens comprising a substantially circular optic zone that includes the optic axis of the lens and is defined by an outermost optic zone perimeter, a peripheral zone substantially adjacent to and circumscribing the optic zone perimeter, and a peripheral edge zone circumscribing the peripheral zone, wherein the optic zone has a radius from the center of the optic zone to the outermost optic zone perimeter of less than or equal to 2.5 mm, wherein the optic zone is the only region of the contact lens that provides clear visual acuity to the person in an eye on which the contact lens is placed, and the contact lens is effective in reducing progression of myopia in the eye of the person, and wherein the optic zone provides a visual acuity A, the peripheral zone provides a visual acuity B, such that the relationship of B to A is defined by the following equation: B<(A+0.05).

16. The method of claim 15, wherein the forming comprises cast molding a polymerizable composition into the shape of a contact lens, separating the cast molded contact lens from a contact lens mold member, contacting the separated cast molded contact lens with a liquid, inspecting the separated cast molded contact lens, packaging the separated cast molded contact lens in a contact lens package, or sterilizing the contact lens in the package, or combinations thereof.
